(19) United States
(12) Patent Application Publication
(10) Pub. No.: US 2017/0245539 A1
(43) Pub. Date: Aug. 31, 2017

(54) COMPOSITON AND METHOD FOR NUTRITION FORMULATION

(71) Applicants: Paul Phuong Do, Markham (CA); Sherri-Ann Harrison, Whitby (CA)

(72) Inventors: Paul Phuong Do, Markham (CA); Sherri-Ann Harrison, Whitby (CA)

(21) Appl. No.: 15/595,637

(22) Filed: May 15, 2017

Related U.S. Application Data
(63) Continuation-in-part of application No. 14/071,533, filed on Nov. 4, 2013.
Application No. 14/071,533 is a continuation-in-part of application No. PCT/CA2013/000440, filed on May 3, 2013.
(60) Provisional application No. 61/642,988, filed on May 4, 2012.

(51) Int. Cl. A23L 33/105; A23L 33/145; A23L 33/125; A23L 33/19; A23L 33/00

(52) U.S. Cl. CPC A23L 33/105; A23L 33/19; A23L 33/40; A23L 33/125; A23L 33/145; A23L 33/30

(57) ABSTRACT

Nutritional compositions are provided herein for optimizing fats, carbohydrates, and protein caloric ratios as they relate to balanced nutrition, general health, and muscle performance during exercise and to muscle cell repair and recovery following the cessation of exercise.

### RELATED APPLICATIONS

This application is a continuation-in-part of U.S. application Ser. No. 14/071,533, filed Nov. 4, 2013, which is a continuation-in-part of International Application No. PCT/CA2013/000440, filed May 3, 2013, which claims the benefit of U.S. Provisional Application No. 61/642,988, filed May 4, 2012. The entire contents of each of these disclosures is hereby incorporated by reference.

### TECHNICAL FIELD

The present invention relates to balanced nutrition and more specifically to compositions and processes that result in nutrient dense food products.

### BACKGROUND

The popularity of nutritious foods has grown rapidly in recent years. Nutrition bars are convenient vehicles for snacks intended to boost energy, and the addition of new and/or trendy health based ingredients have changed the way the industry manufactures common household foods such as muffins and other healthy candy-type snacks.

For general health and recovery, it is important to understand the optimal ratio of caloric intake for daily consumption of foods. Ideally, caloric intake consists of a balanced diet and comes from quality fats, quality carbohydrates, and quality proteins.

Fats are needed to help absorb fat soluble vitamins and cushion the vital internal organs. Unsaturated fats (for example, chia seeds and avocados) are referred to herein as quality fats. Research shows that consumption of monounsaturated and polyunsaturated fats can decrease the risk of breast cancer, reduce cholesterol levels, lower risk for heart disease and stroke, promote weight loss, yield less severe pain and stiffness for sufferers of rheumatoid arthritis, and reduce belly fat. Omega 3, 6, 9 essential fatty acids have numerous health benefits. Omega 3 and 6 fatty acids cannot be produced in the body and must come from external food sources. Omega 3 and 6 fatty acids are converted into eicosapentaenoic acid (EPA) and docosahexaenoic acid (DHA) in the body, and are highly unsaturated fats that play a significant role in brain, eye, and skin health and vitality.

Carbohydrates are the main energy source for the body. Simple carbohydrates are derived from natural sugars in fruit and are a source for instant energy, while complex carbohydrates from vegetables provide fibre for sustained energy. Carbohydrates are very important in the maintenance of blood sugar levels. Glucose is converted in the liver to glycogen for storage. When needed, the liver converts glycogen back into glucose and releases it into the blood stream at intervals to regulate blood sugar levels. Carbohydrates encourage growth of beneficial intestinal bacteria that are involved in the production of certain vitamins and the absorption of calcium and phosphorous. Carbohydrates are needed for quick energy to allow the available protein to be used for building and repairing tissue. If the quantity of carbohydrates consumed is insufficient to supply energy, the body starts to burn its own tissue to supply energy.

Carbohydrates are also needed for the proper use of fats. If lower levels of carbohydrates are consumed, then larger than normal amounts of fats are called upon to supply energy, the body cannot handle the process of breaking down excess fats and the fat does not burn completely. Abnormal amounts of breakdown products build in the blood and cause ketosis.

Proteins are made up of amino acids. The human body links these amino acid chains together in very long chains to create the protein that is required to complete a task which, most often, is for muscle repair (growth), nail and hair growth, and enzyme and hormone production and regulation in the body. Proteins containing all 22 amino acids are complete proteins from animal sources (including eggs, whey protein isolate).

There are nine essential amino acids that are not manufactured by the body and need to be consumed from our foods. Quality proteins contain all nine essential amino acids. The daily protein intake is proportioned to body weight; if too much protein is consumed it is either used as fuel as needed, or converted to fat. Fats are far more difficult for the body to break down; therefore a consistent build-up of protein in the human body over time does more harm than good and leads to ketosis. Failure to consume adequate amounts of protein will lead to the break down of muscle tissue. This causes loss of muscle mass, which is comprised of 20% protein, and triggers poor immune conditions.

Vitamins and minerals that occur naturally in foods are responsible for cell replenishment and play a role in the over 1 million essential chemical reactions the body completes daily. Vitamins (and some minerals) are either water soluble (Vitamins in the B group and Vitamin C, calcium, iron) or fat soluble (Vitamin A, Vitamin D, Vitamin E, Vitamin K).

Vitamins are assimilated in the body when taken with a delivery of vitamin absorbent food. Most fruits and vegetables are 95% water; on the other hand, chia seeds, coconut, or avocados contain highly mono and polyunsaturated fats and constitute optimum food delivery agents which can promote the absorption of vitamins and minerals in the human body.

Nutrient-dense foods provide balanced nutrition for general health and recovery. Additional food supplements for enhancing an athlete's muscle size and strength have become popular substitutes for steroids and other drugs in various sports and body building regimes. However, as athletes continually strive for improved performance, there is a continuing need for non-steroid containing aids for increasing lean mass, muscle size and strength.

Some meal replacement bars for use in conjunction with very low calorie formula diets have been proposed, but these generally do not meet objectives of supplying protein without an excess of carbohydrate. High protein/low carbohydrate baked or compressed products are known; however known bars made by a confectionery process have a poor taste and provide a substitute for one or more meals at a very low calorie dietary regimen, which is much less palatable than, for example, a liquid formula diet.

### SUMMARY

Despite the many previous efforts to formulate muffins, bars, healthy candy type snack foods with proteins, and especially with whey proteins, there remains a need for a nutritious and nutrient dense food that appeals to the palate and contains optimum levels of whey protein, without additives and processing agents. Thus, what is needed is portable food products that have improved nutritional characteristics for balanced nutrition and provide a taste that appeals to the palate.

An object of the present invention is to provide a nutritional formulation that is produced in such a manner as to start with a weight of raw ingredients in various forms and reduce the raw ingredients to one tenth of the starting weight through the manufacturing process, without losing any of the nutrients or micro-nutrients in the original raw ingredients.

Another object of the present invention is to provide a nutritional formulation that includes natural ingredients to act as processing agents and preservatives. The nutritional compositions described herein contain no artificial additives, preservatives or processing agents. That is, all ingredients in the compositions are derived from natural sources, without chemical alteration.

A broad aspect of one aspect of the present invention provides a nutritional composition for optimizing fats, carbohydrates, and protein caloric ratio's as it relates to balanced nutrition, general health, and muscle performance during exercise and for enhancing muscle cell repair and recovery following the cessation of exercise, comprising: a) about 18% to about 23% by weight, e.g. about 19 to about 21%, of whey protein, e.g whey protein isolate; b) about 65% to about 70% e.g., about 67% to about 69%, by weight of a the total of a fruit blend, a concentrated fruit juice and a sweetener e.g., honey; and c) about 10% to about 15% e.g., about 11% to about 13% of a vegetable oil, e.g., olive oil, e,g, extra virgin olive oil; the balance being non-essential, optional or filler ingredients.

A broad aspect of another aspect of the present invention provides a nutritional composition for optimizing fats, carbohydrates, and protein caloric ratio's as it relates to balanced nutrition, general health, and muscle performance during exercise and for enhancing muscle cell repair and recovery following the cessation of exercise, comprising:
a) about 34% to about 39% by weight, e.g. about 35% to about 37% of whey protein, e.g whey protein isolate; and egg whites.
b) about 40% to about 45% by weight, e.g., about 42% to about 44%, by weight of the total of a fruit blend, sweet potato; and
c) about 10% to about 15% by weight e.g., of fats about 12% to about 14% of avocado, and chia seeds; and
d) about 7% to about 12% inclusions e.g., coconut, pumpkin seeds, baking soda and baking fruit as well as very minor amounts of such secondary ingredients as milk, with less than 0.5% lactose from the whey; the balance being non-essential, optional or filler ingredients.

The foregoing summarizes the principal features of the invention and some of its optional aspects. The invention may be further understood by the following description with the accompanying figure.

### BRIEF DESCRIPTION OF THE DRAWINGS

FIG. 1 illustrates a schematic flow chart of a process for a nutrition composition in a muffin/loaf/flat bread/brownie/cookie/cake/cereal/granola/cereal bar format.

FIG. 2 illustrates a schematic flow chart of a process for a nutrition composition in a nutritional bar/vitamin bar/energy bar/protein bar/candy/gelatin liquid drink form/fruit blend powder or frozen treat format.

### DETAILED DESCRIPTION

An essential component of the present invention is to begin the manufacturing process with a starting weight of raw ingredients in various forms and through the manufacturing process, to produce a finished product having one tenth of the starting weight without losing any of the nutrients or micro-nutrients in the original raw ingredients, thus creating a blend of fruit, vegetables and protein, including a non-soy, non-hydrolyzed, non-instantized whey protein isolate. A further essential component of the present invention is that no artificial additives are used in the composition.

Ingredients that can enable such a high concentration of finished product, while retaining the nutritional properties mentioned above are:
Sweet Potato
Carrot
Broccoli
Cauliflower
Kale
Spinach
Beet
Quinoa
Pea Protein
Hemp Protein
Egg Whites
Whey Protein Isolate
Milk Protein
Whey Protein Concentrate
Avocado
Apple
Orange
Pomegranate
Banana
Blackberry
Blueberry
Raspberry
Mango
Cranberry
Dates
Chia Seeds
Hemp
Flax
Coconut
Cocoa Powder
Unsweetened Chocolate
Extra Virgin Olive Oil
Coconut Oil
Avocado Oil
Maple Syrup
Honey
Apple Juice Concentrate
Cinnamon
Baking Powder
Baking Soda
Honey
Custom Natural Flavours
Custom Vitamin Blends

This blend of fruits, vegetables and protein can be provided in multiple edible forms, such as: a “Smoothie”, as a liquid beverage, as a nutrition bar, healthy candy type snacks, as a baked product including muffins, cakes/loafs, cookies, brownies, and flat bread etc., as well as food vitamins, that are pleasant tasting, nutrient dense, and can be readily and conveniently available to the consumer.

As is generally well known, whey protein is a mixture of globular proteins isolated from whey. Whey is left over when milk coagulates and contains everything that is soluble from milk. Whey is usually a 5% solution of lactose in water, and also contains a number of minerals, and lactalbumin. Whey is removed after cheese is processed. The fat is separated from the whey protein and the whey protein is then processed for human foods. Processing consists of varied processes of food treatment, and can range from simple drying, to facilitating the increase of the protein content through the removal of lipids and other non-protein materials. For example, spray drying after membrane filtration separates the proteins from whey.

Whey protein is the collection of globular proteins that are isolated from whey. The protein fraction in whey (approximately 10% of the total dry solids within whey) comprises four major proteins and six minor proteins. The major proteins in whey are beta-lactoglobulin, alpha-lactoglobulin, bovine serum albumin and immunoglobulins. Whey protein is typically a mixture of beta-lactoglobulin (approximately 65%), alpha-lactoglobulin (approximately 25%), and serum albumin (approximately 8%), which are soluble in their native forms, independent of pH.

Whey protein generally may be provided in four major forms:
1) Concentrate: Concentrates typically have a low (but still significant) level of fat and cholesterol but have higher levels of bioactive compounds and carbohydrates in the form of lactose. They are about 29% to 89% protein by weight and are mild to slightly milky in taste.
2) Isolate: Isolates are processed to remove the fat and lactose present in the compound of origin but are usually lower in bio-activated compounds, similar to concentrates mentioned above. They are about 90% or more protein by weight, and are mild to slightly milky in taste. In aspects of the present invention, whey isolates are the preferred form of whey proteins for use.
3) Hydrolysate: Hydrolysates are whey proteins that are predigested and partially hydolyzed for the purpose of easier metabolizing.
4) Instantized: Instantized whey protein concentrate or instantized whey isolate includes “soy lecithin” that is bonded to the fruit, i.e. it is a mixture of whey protein less than 0.5% lactose from the whey.

Protein sources for food compositions can include, for example, eggs, egg whites, and protein products derived from eggs, milk and milk products such as whey and whey protein isolate, and soybeans and soy protein products derived from soybeans. Besides whey proteins, other ingredients that may be included in a protein source and flour substitute in the compositions described herein are egg white protein, milk concentrates, hemp protein, pea protein and quinoa.

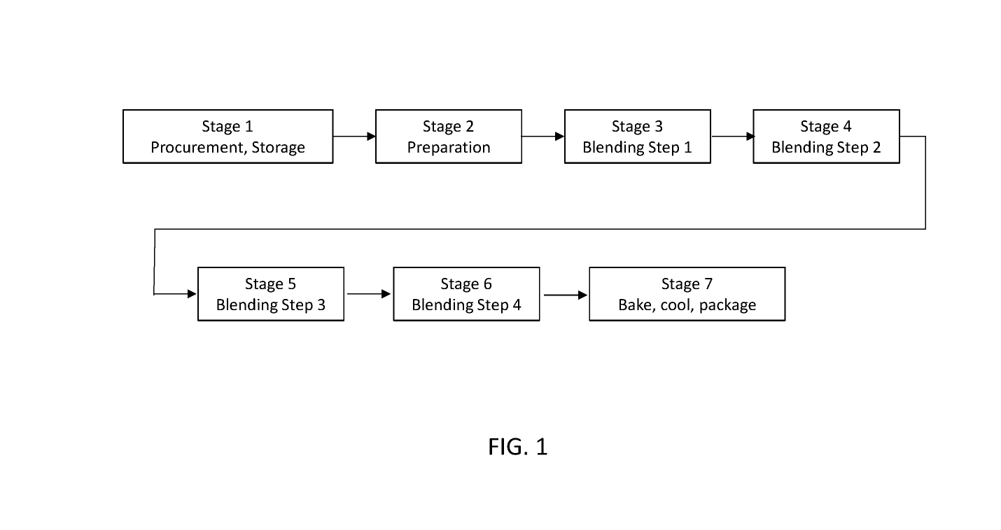

Referring to FIG. 1, preparation of a nutrition product for a muffin, loaf (bread), flat bread, brownie, cookie, cake, cereal, granola, or cereal bar format includes seven stages as described in detail below. or a bar, candy, gelatin drink, powder or frozen food format.

In Stage 1, nutrient dense raw materials are procured. The raw materials are secured with specifications to prove they lack additives or preservatives. Certificate of analysis and other third party testing as required is requested to ensure there are no additives or preservatives. Raw materials are moved to appropriate storage within one hour of receipt.

In Stage 2, raw material is prepared under the correct temperatures, humidity, ventilation and lighting. Vegetable and fruit preparation is specific for each vegetable and fruit: sweet potato, carrot, apple and orange is shredded; apple is diced; apple, banana, kale and spinach is dehydrated and flaked; beets are boiled and shred; broccoli and cauliflower are parboiled and shred; pomegranate and berries are pressed to juice; berries are blended; avocado is whipped; mango and dates are sliced. Raw vegetables and fruits that are prepared for curing are placed in the correct storage location for 24 hours. Some are allowed to soak in their juice during the curing, which concentrates the natural sugars that are used in the downstream process.

Stage 3 is a first blending step, in which egg whites are mixed on high speed for 10 minutes. This step is completed to whip and break down fats as well as to break down proteins to peptides and amino acids. The fats act as lubricant in the successive steps, while the peptides and amino acids act as dough enhancer.

Stage 4 is a second blending step. Baking powder and baking soda is added to the egg whites and mixed for 15 minutes at medium speed. Avocado is then added and mixed at high speed for 5 minutes. Importantly, at this stage the mixing/whipping of the avocado breaks down the fats, which act as an emulsifier, as well as creates an alternate anti-stalling source.

Stage 5 is a third blending step. At this step, protein (whey protein, pea, hemp, and/or milk) is added to the mixing bowl and mixed at high speed for 10 minutes. The protein is whipped and cured to further function as a dough enhancer and nutrients concentration. To cure, the mixture is allowed to stand for 20 minutes to ensure the mixture is homogeneous prior to continuing the process. The friction breaks down the proteins and the mixing and combination of the two protein types (egg white and whey) aids in denaturing or unfolding of the proteins and peptides, allowing them to be bioavailable in a digestive system and in a larger quantity. The protein breakdown and denaturation also creates increased absorption and therefore effectively increases the nutritive content of the composition. Adding and whipping the whey proteins into the mixture including egg white proteins at this stage is essential because it allows the product to “set”, rather than becoming flattened and liquid upon baking.

Stage 6 is a fourth blending step. Vegetables are added and mixed at high speed for 10 minutes. The mixture is then cured to concentrate the nutrients, which act as a flavour enhancer and provide natural antimicrobial properties. At this stage, any other inclusions are also added and mixed for 7 minutes at high speed.

Stage 7 is a baking, cooling and packaging step.

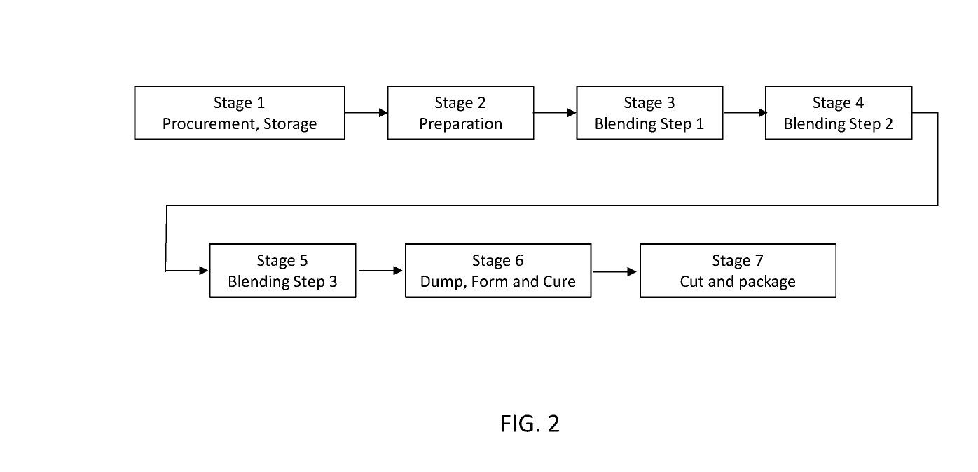

Referring to FIG. 2, preparation of a nutrition product for a bar, candy, gelatin drink, powder or frozen food format includes seven stages as described in detail below.

In Stage 1, nutrient dense raw materials are procured. The raw materials are secured with specifications to prove they lack additives or preservatives. Certificate of analysis and other third party testing as required is requested to ensure there are no additives or preservatives. Raw materials are moved to appropriate storage within one hour of receipt.

In Stage 2, raw material is prepared under the correct temperatures, humidity, ventilation and lighting. Vegetable and fruit preparation is specific for each vegetable and fruit: sweet potato, carrot, apple and orange is shredded; apple is diced; apple, banana, kale and spinach is dehydrated and flaked; beets are boiled and shred; broccoli and cauliflower are parboiled and shred; pomegranate and berries are pressed to juice; berries are blended; avocado is whipped; mango and dates are sliced. Raw vegetables and fruits that are prepared for curing are placed in the correct storage location for 24 hours. Some are allowed to soak in their juice during the curing, which concentrates the natural sugars that are used in the downstream process.

Stage 3 is a first blending step, in which liquid ingredients (honey, apple juice concentrate, maple syrup) are brought to a full boil in a kettle. Any fruit or flavours are added to the kettle and agitated for 2 minutes.

Stage 4 is a second blending step in which an oil source is added. Half the ingredients from the kettle are added to an oil source in a mixing bowl and mixed at medium speed for 20 minutes. Protein is then added and the remainder of the ingredients from the kettle, and mixed at low speed for 10 minutes. The mixture is then mixed at medium speed for 40 minutes. The whipping and curing further function as a stabilizer.

Stage 5 is a third blending step. At this step, the mixture is cooled to 18° C. and any vitamins may be added, followed by mixing at low speed for 2 minutes.

Stage 6 is a forming and curing step. The mixture is dumped, formed and cured. The curing allows for nutrient concentration.

Stage 7 is a cutting and packaging step.

### EXAMPLES

### Example 1

### Pre Nutritious Formula Bar and Nutritious Formula Bar

The “Nutritious Formula Bar” is nutrient dense and contains 25 g of natural carbohydrates consisting of fruit, honey and fruit juice. It contains 5 g of omega 9 rich fat consisting of extra virgin olive oil, 10 g of organic isolated protein consisting of whey protein isolate and 12 g of fruit blend with high nutrient content and antioxidant quality fruit. “Fruit blend” is a mixture of two or more fruits, made from whole fruit and/or juice of the fruit and/or juice concentrate of the fruit.

The Nutritious Formula Bar also contains espresso from 100% Brazilian coffee beans, which provide physical energy and mental alertness without fatigue. The Nutritious Formula Bar provides essential calories allowing for the excessive burn of calories and fats and the inevitable muscle breakdown. The energy thus supplied enables boosting workout and optimizing performance.

The Nutritious Formula Bar is made with fruits, which provide fruit fibre and the essential carbohydrates required to stimulate insulin release. The carbohydrates and amino acids from protein thus provided enable the body to rebuild muscle and energy sources.

The Pre-Nutritious Formula Bar contains the following primary ingredients, namely, honey, whey protein isolate, extra virgin olive oil, apple juice concentrate, coffee, banana fruit, apple fruit, cocoa fruit, mango fruit, pineapple fruit, blackberry fruit, blueberry fruit, cranberry fruit, pomegranate fruit as well as ingredients as milk with less than 0.5% lactose from the whey.

The Nutritious Formula Bar contains the following primary ingredients, namely, honey, whey protein isolate, apple juice concentrate, extra virgin olive oil, banana fruit, apple fruit, cranberry fruit, blueberry fruit, blackberry fruit, pomegranate fruit, as well as ingredients such as milk with less than 0.5% lactose from the whey.

The broad range and optimum range of ingredients are:
Whey protein isolate; about 18% to about 23%; about 19% to about 21%;
Extra virgin olive oil: about 10% to about 15%; about 11% to about 13%; and
Total amounts of the other primary ingredients: about 65% to about 70%; about 67% to about 69%.

The benefits of these primary ingredients may be summarized as follows:

Honey: Honey is carbohydrate-rich and provides a fuel source for all workout muscles.

Whey protein: Whey protein is a complete protein containing all 22 amino acids and all 9 essential amino acids in amounts proportional to the needs of the human body.

Extra virgin olive oil: Extra virgin olive oil controls levels of low density lipoproteins while increasing levels of high density lipoproteins. It contains a large amount of oleic acid.

Apple juice concentrate: Apple juice is rich in pectin and has a high content of the minerals potassium, calcium, phosphorus and magnesium as well as lesser amounts of the metals iron, manganese, copper, and zinc. It is a powerful anti-oxidant, and an anti-inflammatory and anti-histamine agent.

Coffee beans: Coffee contains the alleged anti-cancer compound methylpyridinium, which is formed during the roasting of the raw coffee beans.

Banana: Bananas are rich in potassium an electrolyte necessary for proper working of body cells. Potassium regulates the heartbeat and the function of the muscles.

Dark cocoa bean: Cocoa contains a large concentration of anti-oxidants.

Apple fruit: Apples contain a high concentration of soluble fibre that minimizes blood sugar swings.

Mango: Mangos contain a high concentration of vitamin C, which can strengthen the immune system of the human body.

Pineapple: Pineapples contain a high concentration of manganese, which is needed to build bone and connective tissue.

Blackberry: Blackberries are a source of lycopene and ellagic acid, which is alleged to prevent cell damage. Blackberries also contain Vitamin E.

Blueberry: Blueberries contain ellagic acid.

Cranberry: Cranberries maintain urinary tract health.

Pomegranate fruit: Pomegranates contain phytochemicals, lutein for good vision and Vitamin C.

Other minor secondary ingredients are ones that are used in the processing of the whey protein isolate, namely milk containing less than about 0.5% lactose

### Example 2

### “Superfruit Blend” Product

The “Superfruit Blend” is an antioxidant rich organic and isolated protein blend that mixes easily with juice, water or any other liquid. The Superfruit Blend supplies dietary fibre directly from fruit. The combination of natural carbohydrates, fruit and honey provide an insulin spike after exercise to stop muscle burning and to allow the protein better to be used for the synthesis of new muscle.

The “Superfruit Blend” contains the following primary ingredients, namely, whey protein isolate, blackberry fruit, cranberry fruit, banana fruit, blueberry fruit, apple fruit, pomegranate fruit, and honey; the following amino acids: alanine, arginine, aspartic acid, cysteine, glutamic acid, glycine, histadine, isoleucine, leucine, lycine, methionine, phenylalanine, proline, serine, threonine, tryptophan, tyrosine and valine; the following proteins: alpha-lactoglobulin, beta-lactoglobulin, glyco-macropeptides, bovine serum albumin, immunoglobulin G and protease peptone 5; as well as ingredients as milk with less than 0.5% lactose from the whey.

The broad range and optimum range of ingredients are:
Whey protein isolate; about 68% to about 72%; about 70% to about 71%; and total amounts of the other primary ingredients: about 25% to about 30%; about 27% to about 29%.

It is preferred, however, to add the whey isolate, the “Superfruit Blend” and the honey in the form of a 70% Whey ISOLATE and 25% “Superfruit Blend” and 5% solid honey granules, which are nuggets of pure solid honey without any artificial flavorings and natural or artificial sweeteners from the stevia family.

### Example 3

### Espressoberry Nutritious Formula Bar

Espresso Berry Nutritious Formula Bar contains dark chocolate and espresso with a caffeine content that is equivalent to one cup of filtered coffee. This provides healthy energy without experiencing jitters or a dramatic blood sugar spike.

The Espressoberry “Nutritious Formula Bar” contains the following primary ingredients, namely, honey, whey protein isolate, extra virgin olive oil, apple juice concentrate, coffee, banana fruit, apple fruit, cocoa fruit, mango fruit, pineapple fruit, blackberry fruit, blueberry fruit, cranberry fruit, pomegranate fruit as well as ingredients such as milk with less than 0.5% lactose from the whey.

The fruit blend is a mixture of banana, apple, mango, pineapple, blackberry, blueberry, cranberry, and pomegranate fruits.

The Espressoberry “Nutritious Formula Bar” is a nutrient dense composition containing 24 g of natural carbohydrates consisting of fruit, honey and fruit juice; 5 g of omega 9 rich fat consisting of extra virgin olive oil; 10 g of whey protein isolate; 8 g of fruit blend consisting of exceptional nutrient richness and antioxidant quality fruit; and natural caffeine from coffee beans.

The broad range and optimum range of ingredients are:
Whey protein isolate; about 18% to about 23%; about 19% to about 21%;
Extra virgin olive oil: about 10% to about 15%; about 11% to about 13%; and
Total amounts of the other primary ingredients: about 65% to about 70%; about 67% to about 69%

### Example 4

### Smoothie Berry “Nutritious Formula Bar”

The Smoothie Berry “Nutritious Formula Bar” contains whey protein isolate in addition to various other ingredients, aiding in keeping a balanced sugar level in the human body. The Smoothie Berry “Nutritious Formula Bar” may be used before or after an exercise regime, in addition to serving as a regular food source.

The Smoothie Berry “Nutritious Formula Bar” is a nutrient dense composition containing 25 g of natural carbohydrates consisting of fruit, honey and fruit juice; 6 g of omega 9 rich fat consisting of extra virgin olive oil; 10 g of whey protein isolate; and 15 g of fruit blend consisting of exceptional nutrient richness and antioxidant quality fruit.

The fruit blend in this composition is a mixture of banana, apple, blackberry, blueberry, cranberry, and pomegranate fruit.

The Smoothie Berry “Nutritious Formula Bar” contains the following primary ingredients, namely, honey, whey protein isolate, apple juice concentrate, extra virgin olive oil, banana fruit, apple fruit, cranberry fruit, blueberry fruit, blackberry fruit, pomegranate fruit, as well as ingredients such as milk with less than 0.5% lactose from the whey.

The broad range and optimum range of ingredients are:
Whey protein isolate; about 18% to about 23%; about 19% to about 21%;
Extra virgin olive oil: about 10% to about 15%; about 11% to about 13%; and
Total amounts of the other primary ingredients: about 65% to about 70%; about 67% to about 69%

### Example 5

### PROTEIN BERRY Nutritious Formula Healthy Candy

The PROTEIN BERRY Nutritious Formula Healthy Candy contains essential nutrients, and can have lower amounts of fat, is low in sodium and contains sweeteners of honey and apple juice concentrate.

The PROTEIN BERRY Nutritious Formula Healthy Candy is a nutrient dense composition containing about 4 g of natural carbohydrates consisting of fruit, honey and fruit juice; about 1 g of omega 9 rich fat consisting of extra virgin olive oil; about 2 g of whey protein isolate; and about 1 g of fruit blend.

The ingredients of PROTEIN BERRY Nutritious Formula Healthy Candy are: honey; whey protein; apple juice concentrate; extra virgin olive oil; banana fruit; apple fruit; cranberry fruit; blueberry fruit; blackberry fruit; fruit pomegranate fruit; milk with less than 0.5% lactose from the whey.

The broad range and optimum range of ingredients are:
Whey protein isolate; about 18% to about 23%; about 19% to about 21%;
Extra virgin olive oil: about 10% to about 15%; about 11% to about 13%; and
Total amounts of the other primary ingredients: about 65% to about 70%; about 67% to about 69%.

### Example 6

### ESPRESSO BERRY Nutritious Formula Healthy Candy

The ESPRESSO BERRY Nutritious Formula Healthy Candy contains dark cocoa and berry with natural espresso that is equivalent to ⅓ cup of coffee in caffeine content. providing a natural energy boost without a dramatic drop in blood sugar levels.

The ESPRESSO BERRY Nutritious Formula Healthy Candy is a nutrient dense composition and contains about 4 g of natural carbohydrates consisting of fruit, honey and fruit juice; about 1 g of omega 9 rich fat consisting of extra virgin olive oil; about 2 g of organic isolated protein consisting of whey protein isolate; and about 1 g of fruit.

The ingredients of ESPRESSO BERRY Nutritious Formula Healthy Candy are: honey, whey protein isolate, extra virgin olive oil, apple juice concentrate, coffee, banana fruit, apple fruit, cocoa fruit, mango fruit, pineapple fruit, blackberry fruit, blueberry fruit, cranberry fruit, pomegranate fruit as well as milk with less than 0.5% lactose from the whey.

The broad range and optimum range of ingredients are:
Whey protein isolate; about 18% to about 23%; about 19% to about 21%;
Extra virgin olive oil: about 10% to about 15%; about 11% to about 13%; and
Total amounts of the other primary ingredients: about 65% to about 70%; about 67% to about 69%.

### Example 7

### Nutrient Dense Food Vitamins—Multi Vitamins and Minerals

NUTRIENT DENSE FOOD VITAMINS—MULTI VITAMIN AND MINERAL bar provides macronutrients that are rich in nutritional and nutrient value. Their ingredients are proteins (which provide tissue repair, immune system function, hormone and enzyme production for lean muscle mass and tone); carbohydrates, which are the primary energy source for the brain and are a source of calories to maintain body weight; and fats, which are considered the most energy-efficient form of food. Macronutrients are the transportation for the micronutrients and vitamins. These nutrients are almost immediately absorbed and used by the body. The NUTRIENT DENSE FOOD VITAMINS—MULTI VITAMIN AND MINERAL is thus a good source of multi-vitamins.

The ingredients of the NUTRIENT DENSE FOOD VITAMINS—MULTI VITAMIN AND MINERAL Bar are honey; whey protein; apple juice concentrate; extra virgin olive oil; banana fruit; apple fruit; blueberry fruit; cranberry fruit; blackberry fruit; pomegranate fruit; and milk with less than 0.5% lactose from the whey.

In addition the Nutrient Dense Food Vitamins—Multi Vitamin and Mineral Bar contains the following vitamins and minerals: Vitamin A, Vitamin D3, Vitamin E, Biotin, Folic Acid, Vitamin B5, Vitamin B1, Vitamin B12, Vitamin B2, Vitamin B6, Vitamin C, Calcium, Copper, Iodine, Iron, Magnesium, Zinc, Choline and Inositol.

The broad range and optimum range of ingredients are:
Whey protein isolate; about 11% to about 16%; about 12% to about 14%;
Extra virgin olive oil: about 12% to about 17%; about 13% to about 15%; and
Total amounts of the other primary ingredients: about 70% to about 75%; about 72% to about 74%.

The Nutrient Dense Food Vitamins—Multi Vitamin and Mineral Bar is a nutrient dense composition and contains 5 g to 25 g of natural carbohydrates consisting of fruit, honey and fruit juice; 1 g to 6 g of omega 9 rich fat consisting of extra virgin olive oil; 1 g to 10 g of whey protein isolate; and 2 g to 15 g of a blend of fruits.

### Example 8

### Nutrient Dense Food Vitamins—Vitamin D With Zinc and Seabuckthorn

NUTRIENT DENSE FOOD VITAMINS—VITAMIN D WITH ZINC AND SEA BUCKTHORN provide macronutrients that are high in nutritional and nutrient value. The ingredients are proteins, which provide tissue repair, immune system function, hormone and enzyme production for lean muscle mass and tone; carbohydrates, which provide a primary energy source for the brain and are a source of calories to maintain body weight; and fats, which are considered the most energy-efficient form of food). The macronutrients are the transportation for the micronutrients and vitamins. These nutrients are almost immediately absorbed and used by the body. The NUTRIENT DENSE FOOD VITAMINS—VITAMIN D WITH ZINC AND SEA BUCKTHORN is thus a good source of multi-vitamins.

Sea buckthorn contains more than 190 compounds in the seeds, pulp and juice. These compounds include Vitamins A, K, E, C, B1, and B2, 42 lipids, organic acids, amino acids, folic acid, tocopherols, flavenoids, phenols, terpenes and tannins. Sea buckthorn also contains 20 mineral elements.

The ingredients of NUTRIENT DENSE FOOD VITAMINS—VITAMIN D WITH ZINC AND SEABUCKTHORN are: honey; whey protein; apple juice concentrate; extra virgin olive oil; banana fruit; apple fruit; mango fruit; blueberry fruit; cranberry fruit; pineapple fruit; blackberry fruit; pomegranate fruit; milk with less than 0.5% lactose from the whey.

In addition, the Nutrient Dense Food Vitamins—Vitamin D with Zinc and Seabuckthorn contains the following vitamins and minerals: Vitamin D3 and Zinc.

The broad range and optimum range of ingredients are:
Whey protein isolate; about 20% to about 25%; about 21% to about 23%;
Extra virgin olive oil: about 10% to about 15%; about 11% to about 13%; and
Total amounts of the other primary ingredients: about 60% to about 65%; about 62% to about 64%.

“Nutrient Dense Food Vitamins—Vitamin D with Zinc and Seabuckthorn” is a nutrient dense composition and contains 4 g to 25 g of natural carbohydrates consisting of fruit, honey and fruit juice; 1 g to 6 g of omega 9 rich fat consisting of extra virgin olive oil; 2 g to 10 g of whey protein isolate; and 2 g to 15 g of fruit blend consisting of exceptional nutrient richness and antioxidant quality fruit.

### Example 9

### NUTRIENT DENSE FOOD VITAMINS—CALCIUM AND MAGNESIUM WITH VITAMIN D

NUTRIENT DENSE FOOD VITAMINS—CALCIUM AND MAGNESIUM WITH VITAMIN D provide macronutrients that are high in nutritional and nutrient value. The ingredients are proteins, which provide tissue repair, immune system function, hormone and enzyme production for lean muscle mass and tone; carbohydrates, which provide primary energy source for the brain and are a source of calories to maintain body weight; fats, which are considered the most energy-efficient form of food. The macronutrients are the mode of transportation for the micronutrients and vitamins. These nutrients are almost immediately absorbed and used by the body. It also is a good source of multi-vitamins.

Calcium is the most abundant mineral in the body and is essential for the formation and repair of bone and teeth and other metabolic activities as well. Magnesium is a mineral necessary for energy metabolism, aids in bone growth and binding of calcium to teeth, etc. Both minerals require each other for their absorption and maximum utilization and Vitamin D aids in the direct absorption of calcium.

The ingredients of NUTRIENT DENSE FOOD VITAMINS—CALCIUM AND MAGNESIUM WITH VITAMIN D are: honey; whey protein; apple juice concentrate; extra virgin olive oil; banana fruit; apple fruit; blueberry fruit; cranberry fruit; blackberry fruit; pomegranate fruit; and milk with less than 0.5% lactose from the whey.

In addition NUTRIENT DENSE FOOD VITAMINS—CALCIUM AND MAGNESIUM WITH VITAMIN D contain the following vitamin and minerals: namely Vitamin D3, Calcium, and Magnesium.

The broad range and optimum range of ingredients are:
Whey protein isolate; about 11% to about 16%; about 12% to about 14%;
Extra virgin olive oil: about 12% to about 17%; about 13% to about 15%; and
Total amounts of the other primary ingredients: about 70% to about 75%; about 72% to about 74%.

NUTRIENT DENSE FOOD VITAMINS—CALCIUM AND MAGNESIUM WITH VITAMIN D is nutrient dense and contains 5 g to 25 g of natural carbohydrates consisting of fruit, honey and fruit juice; 1 g to 6 g of omega 9 rich fat consisting of extra virgin olive oil; 1 g to 10 g of organic isolated protein consisting of whey protein isolate; and 2 g to 15 g of fruit blend consisting of exceptional nutrient richness and antioxidant quality fruit.

The broad range and optimum range of non-essential, optional or filler ingredients for the “Nutritious Formula Bar” and Nutritious Formula Healthy Candy are about 2 to about 8%; about 3 to about 6%.

The flavourings consist of the following: non-essential, optional or filler ingredients which are either pure alcoholic extracts, or spray dried natural, GMO free, and Kosher fruits of one or more of the following: pure allspice (pimento) extract, pure almond extract, amaretto natural flavor blend, pure anise extract, apple natural flavor blend, apricot natural flavor blend, banana natural flavor blend, pure basil extract, pure bergamot extract, blackberry natural flavor blend, blueberry natural flavor blend, bourbon extract natural flavor blend, brandy extract natural flavor blend, bubble gum natural flavor blend, butter natural flavor blend, butter run natural flavor blend, butter scotch natural flavor blend, cappuccino natural flavor blend, caramel natural flavor blend, pure cardamom extract, Caribbean spice extract, Chia natural extract, Champagne extract natural flavor blend, cherry natural flavor blend, chocolate natural flavor blend, white chocolate natural flavor blend, pure cinnamon extract, pure clove extract, coconut natural flavor blend, robust coffee flavor, cranberry natural flavor blend, creme de menthe natural flavor blend, black currant (cassis natural flavor blend, pure “fiori di Sicilia” extract, sautéed natural garlic flavor, Grand Marnier natural flavor blend, Concord grape natural flavor blend, Highlander Grog natural flavor blend, Irish Cream natural flavor blend, pure jasmine extract, pure lavender extract, pure lemon extract, pure key lime extract, pure Mandarin orange natural flavor blend, maple natural flavor blend, pure mint extract, Mocha natural flavor blend, sautéed onion natural flavor blend, pure orange extract, pure orange blossom extract, pure osmanthus extract, Passion fruit natural flavor blend, peach natural flavor blend, pear natural flavor blend, pure pomegranate extract, Pina Colada natural flavor blend, pineapple natural flavor blend, pistachio natural flavor blend, pomegranate natural flavor blend, Pound cake natural flavor blend, pumpkin pie natural flavor blend, raspberry natural flavor blend, pure red pepper extract, red velvet natural flavor blend, pure rose extract, rose water, rum v, pure spearmint extract, strawberry natural flavor blend, pure tangerine extract, natural black tea flavor, natural green tea flavor, English toffee natural flavor blend, black walnut natural flavor blend, water melon natural flavor blend, and pure wintergreen extract.

### Example 10

### NUTRIENT DENSE MUFFINS

The NUTRIENT DENSE MUFFINS ingredients are sweet potatoes, which are anti-oxidants and anti-inflammatory and anti-arthritic agents, and are alleged to prevent stomach ulcers, lymphysema and can aid in digestion; avocado, which provides oleic acid, and is alleged to lower cholesterol; dates, which provide sweet dietary fibre, chia seeds, which provide omega-3 and antioxidants; unsweetened shredded coconut; pumpkin seeds and egg whites, which provide 22 amino acids to help build and repair cells.

The NUTRIENT DENSE MUFFINS contain 7 g of protein from whey protein isolate and 3 g of fibre.

The NUTRIENT DENSE MUFFINS contain the following primary ingredients, namely, Sweet Potato, Carrot
Broccoli
Cauliflower
Kale
Spinach
Beet
Quinoa
Pea Protein
Hemp Protein

Egg Whites, Avocado, Dates, Whey Protein Isolate, BlackBerry fruit, CranBerry fruit, Banana fruit, BlueBerry fruit, Apple fruit, Pomegranate fruit, Orange fruit, Raspberry fruit, Mango fruit, Dark Cocoa Beans, Chia Seeds, Coconut, Pumpkin Seeds, Natural Flavour, Unsweetened Dark Chocolate, Baking Soda, Baking Powder as well as very minor amounts of such secondary ingredients as milk with less than 0.5% lactose from the whey.

The benefit of ingredients in the NUTRIENT DENSE MUFFINS:

Hemp Protein—reduce inflammation and improve circulation, factors of primary importance in the cure and prevention of many diseases. Studies suggest significant improvements in cholesterol and blood pressure. Non-allergenic protein source. Source of essential fatty acids Omega 3, 6.

Pea Protein—non-allergenic protein source. Loaded with branch chain amino acid for muscle repair and building.

Kale—high fibre, vitamin K, iron, is an anti-inflammatory as it contains omega 3 fatty acids, antioxidant containing Vit A and C in high doses. Contains more Calcium content than milk.

Spinach—Contains an antioxidant alpha-lipoic acid which control blood sugar levels. Contain beta-carotene, great for eye and skin health. High is potassium helps in blood pressure regulation.

Beets—an excellent source of folate and manganese. Folate is important for synthesizing and repairing DNA as well as helping with cell division and growth, such as during pregnancy or infancy. Folate also helps to produce red blood cells and prevent anemia.

Broccoli—Contains over RDI of Vit K, aids in calcium absorption. High in Vit C and folate.

Cauliflower—research shows it contains sulforaphane, a sulfur compound that has also been shown to kill cancer stem cells, thereby slowing tumor growth.

Flax—excellent source of Omeg 3 component ALA (alpha-linolenic acid) essential for intestinal health, hair and nail strength.

Quinoa—excellent source of nutrients per cup; Protein: 8 grams, Fiber: 5 grams, Manganese: 58% of the RDA, Magnesium: 30% of the RDA, Phosphorus: 28% of the RDA, Folate: 19% of the RDA, Copper: 18% of the RDA, Iron: 15% of the RDA, Zinc: 13% of the RDA, Potassium: 9% of the RDA.

Sweet potatoes: Sweet potatoes are a source of antioxidants (Vitamins A and C); a source of anti-inflammatory compounds (Vitamins C and B6, beta-carotene, and manganese to help maintain collagen and reduce the risk of developing certain forms of arthritis and to soothe pain and inflammation of ulcers); carotenes (to assist in responding to insulin and stabilize blood sugar); high content of soluble fibre aids in lowering blood sugar and cholesterol); chlorogenic acid (to decrease insulin resistance); B vitamins, vitamin C, potassium, beta-carotene and calcium (help in healing of stomach ulcers); and fibre (helps prevent constipation and acidity).

Egg Whites: Egg whites have proteins which are almost immediately absorbed into the body. They are an excellent source of energy allowing the burning of fat while building muscle. They are low in calories.

Date Fruit: Date fruit contains several nutrients including calcium, fibre, amino acids, sulfur, iron, manganese, magnesium, phosphorus, copper and potassium as well as fats, dietary fibre and Vitamins A1, B1, B2, B3 and B5.

Avocados: Avocados contain such nutrients as Vitamin K, dietary fibre, potassium, Vitamin B6, Vitamin C and Copper. They contain oleic acid a monounsaturated fat that may help power cholesterol.

Unsweetened coconut: Coconut is rich in lauric acid, which is known to be anti-viral, anti-bacterial and anti-fungal while boosting the immune system.

Chia seeds: Chia seeds contain a high value of omega-3 fatty acids, which can keep blood pressure low and blood sugar under control.

Pumpkin seeds: Pumpkin seeds are a good source of phosphorus, magnesium, manganese, zinc, iron, and copper. They contain Vitamin K and proteins, L-tryptiphane, which is a naturally effective protection against osteoporosis, and are effective in reducing inflammation without the side effects of anti-inflammatory drugs.

The broad range and optimum range of ingredients for the NUTRIENT DENSE MUFFINS are:
Protein: whey protein isolate/concentrate, egg whites, hemp protein, pea protein, milk concentrates, quinoa: about 34% to about 39%; about 35% to about 37%;
Carbohydrates: fruit and vegetable blend, i.e., banana, apple, blackberry, blueberry, cranberry, pomegranate, raspberry, mango, orange, fresh sweet potatoes, carrots, spinach, kale, broccoli, cauliflower, beets, quinoa: about 40% to about 45%: about 42% to about 44%
Fat: fresh avocado and chia seeds: about 10% to about 15%; about 12% to about 14%.
Non-essential, optional or filler ingredients: pumpkin seeds and/or coconut and/or cinnamon and/or dates, flax, cocoa powder, unsweetened chocolate, honey: about 7% to about 12%; about 8% to about 10%.

The non-essential, optional or filler ingredients are GMO free (that is, free of genetically modified organisms and products made from them) and Kosher for the NUTRIENT DENSE MUFFINS, include nuts, including almond, brazil nut, cashew, coconut, filbert, pecan, hazelnut, macademia, and walnut; seeds including pumpkin, watermelon , sunflower, flax, chai, squash, pomegranate, grape, poppy and sesame; as well as, dates, figs, apricots, raisins, cranberries, mango, pineapple, carrot, zucchini, apple, banana, blueberries, blackberries, strawberries, raspberries, cherries, passion fruit, star fruit, pomegranate, citrus rind, and cinnamon, nutmeg, pumpkin spice, all spice, and black pepper.

The foregoing has constituted a description of specific embodiments showing how the invention may be applied and put into use. These embodiments are only intended to be exemplary. The invention in its broadest and more specific aspects is further described and defined in the claims that follow.

These claims and the language used therein are to be understood in terms of the variants of the invention that has been described. They are not to be restricted to such variants, but are to be read as covering the full scope of the invention as is implicit within the invention and the disclosure that has been provided herein.

What is claimed is:

1. A nutritional composition comprising about 11% to about 72% by weight of a protein source.

2. The nutritional composition of claim 1, the composition comprising:
a. about 18% to about 23% by weight, of a protein source;
b. about 65% to about 70% by weight, of a fruit blend, a fruit juice concentrate and one or more sweeteners; and
c. about 10% to about 15% by weight, of one or more vegetable oils.

3. The nutritional composition of claim 2, wherein the protein source comprises whey protein isolate, the sweetener comprises honey granules, wherein the honey granules are pure solid honey without any artificial flavourings, artificial sweeteners or stevia; and wherein the fruit blend, concentrated fruit juice and sweetener together comprise 70% by weight, the fruit blend comprises 25% by weight, and the sweetener comprises 5% by weight.

4. The nutritional composition of claim 2, wherein the vegetable oil comprises extra virgin olive oil, coconut oil, corn oil, cottonseed oil, palm oil, peanut oil, canola oil, safflower oil, sesame oil, sunflower oil, almond oil, beech nut oil, cashew oil, hazelnut oil, pecan oil, pine nut oil, pistachio oil, walnut oil, grape seed oil, pumpkin seed oil, watermelon seed oil, or any combination of the foregoing.

5. The nutritional composition of claim 2, wherein the sweetener is selected from the group consisting of: honey, maple syrup, corn syrup, brown rice syrup, agave sugar, evaporated cane juice, maltodextrose, sucralose, invert corn sugar, corn syrup, dextrose, unconverted dextrines, glucose, levulose, maltose, and any combination of the foregoing.

6. The nutritional composition of claim 2 comprising: whey protein isolate having a range of content by weight of about 18% to about 23%; extra virgin olive oil having a range of content by weight of about 10% to about 15%; and fruit blend, apple juice concentrate and honey together comprising by weight about 65% to about 70%; wherein the fruit blend comprises one or more of banana, apple, blackberry, blueberry, mango, pineapple, cranberry and pomegranate; and
wherein the nutritional composition comprises less than 0.5% by weight of lactose.

7. The nutritional composition of claim 1 comprising: whey protein isolate having a range of content by weight of about 68% to about 72%; and fruit blend, fruit juice concentrate, honey, and vegetable oil together comprising about 25% to about 30% by weight, wherein the fruit blend comprises one or more of blackberry, cranberry, banana, blueberry, apple and pomegranate; and further comprising one or more of alanine, arginine, aspartic acid, cysteine, glutamic acid, glycine, histidine, isoleucine, leucine, lysine, methionine, phenylalanine, proline, serine, threonine, tryptophan, tyrosine and valine; and further comprising one or more of alpha-lactoglobulin, beta-lactoglobulin, glyco-macropeptides, bovine serum albumin, immunoglobulin G and protease peptone 5; and wherein the nutritional composition comprises less than 0.5% by weight of lactose.

8. The nutritional composition of claim 1 comprising: whey protein isolate having a range of content by weight of about 11% to about 16%; extra virgin olive oil having a range of content by weight of about 12% to about 17%; and fruit blend, apple juice concentrate and honey together comprising about 70% to about 75% by weight, wherein the fruit blend comprises one or more of banana, apple, blueberry, cranberry, blackberry, pomegranate; and further comprising one or more of vitamin A, vitamin D₃, vitamin E, biotin, folic acid, vitamin B₅, vitamin B₁, vitamin B₁₂, vitamin B₂, vitamin B₆, vitamin C, calcium, copper, iodine, iron, magnesium, zinc, choline and inositol.

9. The nutritional composition of claim 2, wherein the sweetener comprises honey, the fruit juice concentrate comprises apple juice concentrate, the vegetable oil comprises extra virgin olive oil, and the protein source comprises whey protein isolate, and wherein the composition further comprises one or more of banana, apple, blueberry, cranberry, blackberry, pomegranate, vitamin A, vitamin B₁₂, vitamin B₂, vitamin B₆, vitamin D₃, vitamin E, vitamin C, biotin, folic acid, pantothenic acid, calcium, copper, iodine, iron, magnesium, manganese, molybdenum, selenium, zinc, choline, inositol and natural flavours.

10. The nutritional composition of claim 1 comprising whey protein isolate having a range of content by weight of about 20% to about 25%; extra virgin olive oil having a range of content by weight of about 10% to about 15%; and fruit blend, apple juice concentrate and honey together comprising about 60% to about 65% by weight, wherein the fruit blend comprises one or more of banana, apple, mango, blueberry, cranberry, pineapple, blackberry, and pomegranate; the composition further comprising one or more of vitamin D₃, zinc, sea buckthorn, and less than 0.5% lactose by weight from the whey protein isolate.

11. The nutritional composition of claim 1 comprising whey protein isolate having a range of content by weight of about 11% to about 16%; and extra virgin olive oil having a range of content of about 12% to about 17%; and honey, apple juice concentrate, and fruit blend together comprising about 70% to about 75%;
wherein the fruit blend comprises one or more of banana, apple, blueberry, cranberry, blackberry, and pomegranate; and further comprises calcium, magnesium, and vitamin D₃.

12. The nutritional composition of claim 2 wherein the composition is in a form selected from the group consisting of: a liquid drink form, an energy bar, a protein bar, a candy, a cereal bar, a gelatin, a fruit blend, and a frozen treat.

13. The nutritional composition of claim 1 comprising a protein component having a range of content by weight of about 34% to about 39%, the protein component comprising egg whites and whey protein isolate, wherein the whey protein isolate provides less than 0.5% lactose by weight; a carbohydrate component having a range of content by weight of about 40% to about 45%, the carbohydrate component comprising one or more of sweet potato, banana, apple, blackberry, blueberry, cranberry, and pomegranate; a fat component having a range of content by weight of about 10% to about 15%, the fat component comprising one or more of chia seeds and avocado; the composition further comprising one or more of natural flavour, baking soda, pumpkin seeds, coconut, cinnamon and dates, together having a range of content of about 7% to about 12%.

14. The nutritional composition of claim 13, further comprising one or more of almond, Brazil nut, cashew, coconut, filbert, pecan, hazelnut, macadamia nut, walnut, pumpkin seed, watermelon seed, sunflower seed, flax seed, chai seed, squash seed, pomegranate seed, grape seed, poppy seed, sesame seed, dates, figs, apricots, raisins, cranberries, mango, pineapple, carrot, zucchini, apple, banana, blueberries, blackberries, strawberries, raspberries, cherries, passion fruit, star fruit, pomegranate, citrus rind, cinnamon, nutmeg, pumpkin spice, all spice, and black pepper.

15. The nutritional composition of claim 13 in a form selected from the group consisting of: a muffin, a cake, a loaf, a cookie, a brownie and a flat bread.

16. A method for producing a nutrition composition without preservatives and processing agents, the method comprising:
a. Preparing a mixture by adding egg whites and beating;
b. Adding baking powder and baking soda to the mixture and mixing;
c. Adding avocado to the mixture and mixing;
d. Adding whey protein to the mixture, whipping and curing the mixture;
e. Adding vegetables to the mixture and mixing; and
f. Baking, cooling and packaging the mixture.

17. A method for producing a nutrition composition without preservatives and processing agents, the method comprising:
a. Preparing a mixture by cooking honey, apple juice concentrate and maple syrup;
b. Adding proteins to the mixture and mixing;
c. Adding vitamins to the mixture and mixing;
d. Curing the mixture to provide a concentrated nutrition mixture; and
e. Cutting and packaging the mixture.
